(19) United States
(12) Patent Application Publication
(10) Pub. No.: US 2024/0306608 A1
(43) Pub. Date: Sep. 19, 2024

(54) MUTUAL ENGAGEMENT STRUCTURE FOR A PET LEASH

(71) Applicant: WEVER CO., LTD., New Taipei City (TW)

(72) Inventor: Chen Wei Chi, New Taipei City (TW)

(21) Appl. No.: 18/120,440

(22) Filed: Mar. 13, 2023

(51) Int. Cl. A01K 27/00

(52) U.S. Cl. CPC A01K 27/003

(57) ABSTRACT

A mutual engagement structure for a pet leash, comprising: a main body comprising a first part and a second part, wherein the first part and the second part are coupled to each other separably so as to form the main body; a first coupling portion provided on a side of the first part that faces the second part; a second coupling portion provided on a side of the second part that faces the first part, wherein the second coupling portion and the first coupling portion are coupled to each other separably enabling the first part and the second part to form the main body; a first positioning portion provided on the side of the first part that faces the second part; and a second positioning portion provided on the side of the second part that faces the first part, wherein the second positioning portion and the first positioning portion are coupled to each other separably.

### BACKGROUND OF THE INVENTION

### 1. Field of the Invention

The present invention generally relates to a mutual engagement structure for a pet leash and, more particularly, to a mutual engagement structure for a pet leash which is easy to assemble and separate, and is not easy to loosen.

### 2. Description of the Related Art

For a pet leash of the prior art, especially the pet leash that is often used for pulling dogs, a loop will be formed in an end of a rope of the pet leash by bending a portion of the rope. Users can hold or grasp the loop to control the activity of dog at the other end of the rope by the rope. Users sometimes need to use the pet leash to restrict the dog's activity within a limited area. For example, when users want to enter a store where the dog is not allowed to enter, it is necessary to tie up the dog temporarily to railings or other fixed objects outside the store. As a result, a structure for users to open and close the loop is usually disposed at the loop used for users holding or grasping for the pet leash of prior art.

Taiwanese Utility U.S. Pat. No. 84,218,001 discloses a modified structure for pet leash, which utilizes a bolt snap having a spring latch in the prior art and a ring body of an adjusting pin to open or close the loop. This structure using the spring latch as a fastening structure requires both of users' hands to operate. The structure can be buckled together accurately by one hand holding the bolt snap and the other hand holding the ring body. Besides, this structure using the bolt snap with the spring latch is easily damaged because of careless operation or insufficient spring elasticity so that the dogs would be easily to get rid of the structure. Furthermore, more components used in the structure also lead more assembly costs.

Therefore, how to provide a mutual engagement structure for a pet leash that is easy to operate and has a simple and firm structure has become an urgent problem to be solved in the industry.

### SUMMARY OF THE INVENTION

In light of solving the foregoing problems of the prior art, the present invention provides a mutual engagement structure for a pet leash, comprising: a main body comprising a first part and a second part, wherein the first part and the second part are coupled to each other separably so as to form the main body; a first coupling portion provided on a side of the first part that faces the second part; a second coupling portion provided on a side of the second part that faces the first part, wherein the second coupling portion and the first coupling portion are coupled to each other separably in order for the first part and the second part to form the main body; a first positioning portion provided on the side of the first part that faces the second part; and a second positioning portion provided on the side of the second part that faces the first part, wherein the second positioning portion and the first positioning portion are coupled to each other separably.

In an embodiment, the first coupling portion has groove structures formed respectively in two opposite edges of the side of the first part that faces the second part, and the second coupling portion has protruding structures formed respectively on two opposite edges of the side of the second part that faces the first part.

In an embodiment, the first coupling portion has protruding structures formed respectively on two opposite edges of the side of the first part that faces the second part, and the second coupling portion has groove structures formed respectively in two opposite edges of the side of the second part that faces the first part.

In an embodiment, the first positioning portion is a generally hemispherical protuberance, and the second positioning portion is a generally hemispherical recess corresponding to the generally hemispherical protuberance.

In an embodiment, the side of the second part that faces the first part further comprises a guide groove, and the guide groove is substantially parallel to the second coupling portion and is connected to the second positioning portion.

In an embodiment, the first positioning portion is made of a magnetic material, and the second positioning portion is made of a ferromagnetic material; or the first positioning portion is made of the ferromagnetic material, and the second positioning portion is made of the magnetic material.

In an embodiment, the first positioning portion is formed with a cavity with its opening facing the second positioning portion, and the first positioning portion further comprises a positioning ball with more than one half of its volume is located in the cavity; and wherein the second positioning portion is a positioning hole, and the positioning ball and the positioning hole are coupled to each other separably.

In an embodiment, the first positioning portion further comprises a spring provided between the positioning ball and a bottom portion of the cavity such that the positioning ball is limitedly movable determined by an elastic force of the spring.

In an embodiment, the positioning ball is made of a magnetic material, and the second positioning portion is made of a ferromagnetic material; or the positioning ball is made of the ferromagnetic material, and the second positioning portion is made of the magnetic material.

In an embodiment, the first positioning portion is formed with a cavity with its opening facing the second positioning portion, and the first positioning portion further comprises a positioning ball and a first sleeve provided in the cavity, and the positioning ball is provided in the first sleeve with more than one half of its volume located in the first sleeve; and wherein the second positioning portion is a positioning hole, and the second positioning portion further comprises a second sleeve provided in the positioning hole, and wherein the positioning ball and the second sleeve are coupled to each other separably.

In an embodiment, the first positioning portion further comprises a spring provided in the first sleeve, and the spring is provided between the positioning ball and a bottom portion of the cavity such that the positioning ball is limitedly movable determined by an elastic force of the spring.

In an embodiment, the positioning ball is made of a magnetic material, and the second sleeve is made of a ferromagnetic material; or the positioning ball is made of the ferromagnetic material, and the second sleeve is made of the magnetic material.

In an embodiment, the first part has a socket, and the second part has a through hole.

In an embodiment, the mutual engagement structure for a pet leash further comprises a rope, wherein the rope has a first end and a second end opposite to the first end, and the first end of the rope is fixedly provided in the socket, and the second end of the rope passes through and protrudes from the through hole, and a portion of the rope is fixedly provided in the through hole.

In an embodiment, the mutual engagement structure for a pet leash further comprises a rope, wherein the rope has a first end and a second end opposite to the first end, and the first end of the rope is provided in the socket, and the second end of the rope passes through and protrudes from the through hole, and a portion of the rope is provided in the through hole.

In an embodiment, the mutual engagement structure for a pet leash further comprises a first fixing element and a second fixing element, wherein the first part comprises a first through bore, and the first through bore extends through the socket and penetrates the first part; wherein the second part comprises a second through bore, and the second through bore extends through the through hole and penetrates the second part; and wherein the first fixing element passes through the first through bore and penetrates the rope in the socket, and the second fixing element passes through the second through bore and penetrates the rope in the through hole.

In an embodiment, the mutual engagement structure for a pet leash further comprises a fastening element, wherein the fastening element is coupled to the second end of the rope detachably.

In an embodiment, the first part is provided with a first anti-slip portion, and the first anti-slip portion and the first coupling portion are provided on two opposite sides of the first part respectively; or the second part is provided with a second anti-slip portion, and the second anti-slip portion and the second coupling portion are provided on two opposite sides of the second part respectively.

Compared to the prior art, the mutual engagement structure for a pet leash of the present invention utilizes the structures comprising the first part and the second part coupled to each other separably, together with the first coupling portion and the first positioning portion provided on the first part, and the second coupling portion and the second positioning portion provided on the second part so that the users could easily open or close the loop when the rope is fixedly provided on the first part and the second part. It can be easily and accurately operated by one-hand for the users. Besides, the first coupling portion and the second coupling portion have respectively corresponding protruding structures and groove structures, which can increase the stability of the closed loop. Furthermore, the first positioning portion and the second positioning portion are respectively corresponding hemispherical protuberance and hemispherical recess, which can increase the positioning effect of the combination of the first part and the second part. In particular, when the first positioning portion and the second positioning portion are respectively made of magnetic material and ferromagnetic material, it can further increase the positioning and coupling effects of the first part and the second part. Therefore, the mutual engagement structure for a pet leash of the present invention can be effectively solved the deficiencies of the prior art.

### BRIEF DESCRIPTION OF THE DRAWINGS

FIG. 1 illustrates a schematic view of a structure of the mutual engagement structure for a pet leash according to one embodiment of the present invention.

FIG. 2 illustrates a schematic section view of a structure of the mutual engagement structure for a pet leash according to another embodiment of the present invention.

FIG. 3 illustrates a schematic view of a structure of the mutual engagement structure for a pet leash for application according to another embodiment of the present invention.

FIG. 4 illustrates a schematic view of a structure of the mutual engagement structure for a pet leash according to another embodiment of the present invention.

### DETAILED DESCRIPTION

The present invention is described by the following specific embodiments. Those with ordinary skills in the arts can readily understand other advantages and functions of the present invention after reading the disclosure of this specification. Any changes or adjustments made to their relative relationships, without modifying the substantial technical contents, are also to be construed as within the range implementable by the present invention.

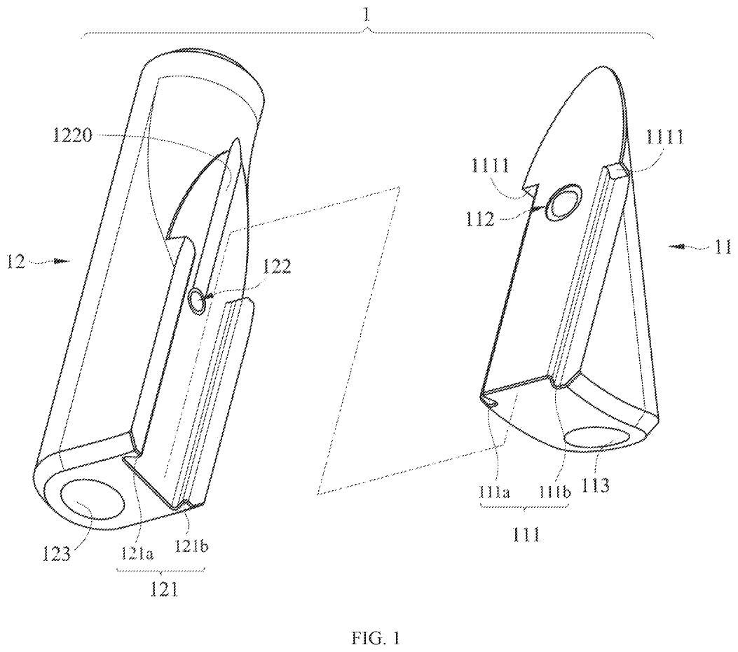

Please refer to FIG. 1. FIG. 1 illustrates a schematic view of a structure of the mutual engagement structure for a pet leash according to one embodiment of the present invention. The present invention provides a mutual engagement structure for a pet leash, comprising a main body 1 which comprises a first part 11 and a second part 12, wherein the first part 11 and the second part 12 are coupled to each other separably so as to form the main body 1. In this embodiment, the first part 11 and the second part 12 forming the main body 1 may be made of plastic materials. In other embodiments, the first part 11 and the second part 12 may be made of other materials such as metal or wood.

As shown in FIG. 1, in this embodiment, the mutual engagement structure for a pet leash of the present invention may further comprise a first coupling portion 111 and a second coupling portion 121. The first coupling portion 111 may be provided on a side of the first part 11 that faces the second part 12. The second coupling portion 121 may be provided on a side of the second part 12 that faces the first part 11. The second coupling portion 121 and the first coupling portion 111 are coupled to each other separably enabling the first part 11 and the second part 12 to form the main body 1.

As shown in FIG. 1, the first coupling portion 111 is provided on a surface of the first part 11 that faces the second part 12 and the second coupling portion 121 is provided on a surface of the second part 12 that faces the first part 11. The first coupling portion 111 may have groove structures 111a and 111b formed respectively in two opposite edges of the surface of the first part 11 that faces the second part 12. The second coupling portion 121 may have protruding structures 121a and 121b formed respectively on two opposite edges of the surface of the second part 12 that faces the first part 11, wherein the groove structures 111a and 111b of the first coupling portion 111 may be respectively coupled to the protruding structures 121a and 121b of the second coupling portion 121. Specifically, a length of the first coupling portion 111 is substantially the same as a length of the second coupling portion 121. More specifically, a length of each of the groove structures 111a and 111b is substantially the same as a length of each of the protruding structures 121a and 121b. Preferably, the first coupling portion 111 further comprises stop portions 1111 provided respectively at two tops of the groove structures 111a and 111b. When the protruding structures 121a and 121b of the second coupling portion 121 are coupled to the groove structures 111a and 111b of the first coupling portion 111, respectively, the stop portion 1111 may restrict a position where the second coupling portion 121 is coupled to the first coupling portion 111.

In other embodiments (not shown in drawings), the first coupling portion 111 may have protruding structures formed respectively on two opposite edges of the surface of the first part 11 that faces the second part 12. The second coupling portion 121 may have groove structures formed respectively in two opposite edges of the surface of the second part 12 that faces the first part 11. The protruding structures formed by the first coupling portion 111 may be respectively coupled to the groove structures formed by the second coupling portion 121. More specifically, a length of the first coupling portion 111 is substantially the same as a length of the second coupling portion 121. Preferably, the second coupling portion 121 further comprises stop portions (not shown in drawings) provided respectively at two tops of the groove structures. When the protruding structures formed by the first coupling portion 111 are coupled to the groove structures formed by the second coupling portion 121, the stop portions may restrict a position where the first coupling portion 111 is coupled to the second coupling portion 121.

As shown in FIG. 1, the mutual engagement structure for a pet leash of the present invention may further comprise a first positioning portion 112 and a second positioning portion 122. In this embodiment, the first positioning portion 112 may be provided on the surface of the first part 11 that faces the second part 12. The second positioning portion 122 may be provided on the surface of the second part 12 that faces the first part 11. The second positioning portion 122 and the first positioning portion 112 may be coupled to each other separably. In an embodiment of the present invention, as shown in FIG. 1, the first positioning portion 112 may be a generally hemispherical protuberance, and the second positioning portion 122 may be a generally hemispherical recess corresponding to the generally hemispherical protuberance of the first positioning portion 112. When the first positioning portion 112 is substantially close to the second positioning portion 122 during the process of coupling the first coupling portion 111 and the second coupling portion 121, it is easier to achieve the effect of positioning by the structures, the generally hemispherical protuberance and the generally hemispherical recess.

As shown in FIG. 1, preferably, in another embodiment of the present invention, the side of the second part 12 that faces the first part 11 further comprises a guide groove 1220. The guide groove 1220 may be substantially parallel to the second coupling portion 121 and may be further connected to the generally hemispherical recess of the second positioning portion 122. In this embodiment, the guide groove 1220 may be a long trench with concave U-shaped bottom corresponding to the generally hemispherical protuberance formed by the first positioning portion 112. During the process of coupling the first coupling portion 111 and the second coupling portion 121, the generally hemispherical protuberance formed by the first positioning portion 112 would be coupled to the corresponding second positioning portion 122 by the guide groove 1220 more accurately.

In other embodiments, the first positioning portion 112 may be a generally hemispherical recess, and the second positioning portion 122 may be a generally hemispherical protuberance corresponding to the generally hemispherical recess. The effect of positioning during the process of coupling the first coupling portion 111 and the second coupling portion 121 would be achieved. Similarly, in this embodiment, the second part 12 may further comprise the guide groove 1220. The first positioning portion 112 may be coupled to the corresponding the second positioning portion 122 by the guide groove 1220 more accurately.

In another embodiment of the present invention, preferably, the first positioning portion 112 may be made of a magnetic material such as iron, cobalt, nickel, copper or a composite material of a combination thereof, and the second positioning portion 122 may be made of a ferromagnetic material. When the first positioning portion 112 and the second positioning portion 122 are close to each other, the first coupling portion 111 and the second coupling portion 121 could be coupled to each other in a predetermined position more quickly and accurately by the magnetic suction. In other embodiments, the first positioning portion 112 may be made of a ferromagnetic material, and the second positioning portion 122 may be made of a magnetic material. The aforementioned effect of positioning faster and more accurately can be achieved.

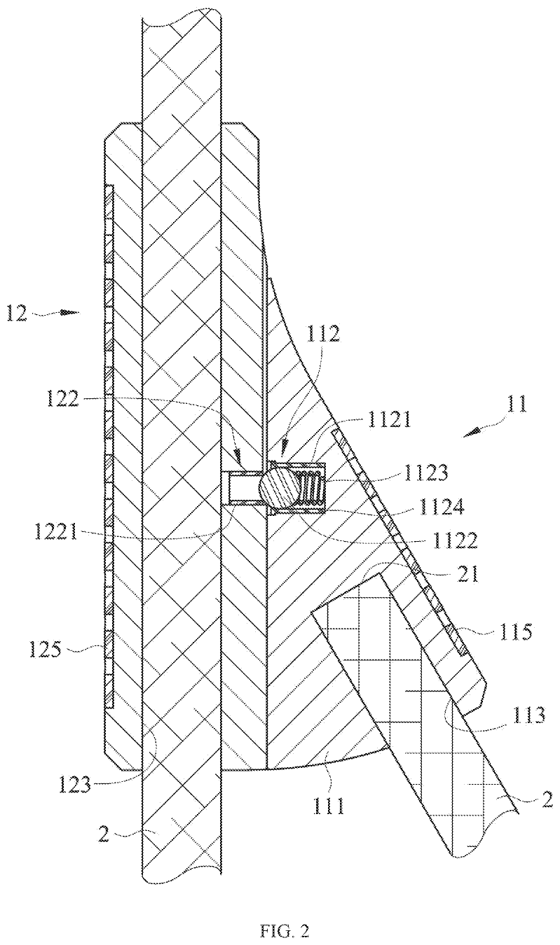

Please refer to FIG. 2. In another embodiment of the present invention, preferably, the first positioning portion 112 is formed with a cavity 1121 with its opening facing the second positioning portion 122, and the first positioning portion 112 may further comprise a positioning ball 1122, and more than one half of the volume of the positioning ball 1122 may be located in the cavity 1121. The second positioning portion 122 may be a positioning hole, and the positioning ball 1122 and the positioning hole may be coupled to each other separably. In a more preferable embodiment, the first positioning portion 112 may further comprise a spring 1123, and the spring 1123 may be provided between the positioning ball 1122 and a bottom portion of the cavity 1121 such that the positioning ball 1122 may be limitedly movable in the cavity 1121 determined by an elastic force of the spring 1123.

As shown in FIG. 2, in another embodiment, the positioning ball 1122 may be made of a magnetic material, and the second positioning portion 122 may be made of a ferromagnetic material. By cooperating with the aforementioned embodiments, the hemispherical protuberance formed by the positioning ball 1122 protruding from the cavity 1121 and the hemispherical recess formed by the second positioning portion 122 may enhance the effect of positioning. In addition, the magnetic suction between the magnetic material and the ferromagnetic material may further increase the effect of combination of the first positioning portion 112 and the second positioning portion 122. In other embodiments, the positioning ball 1122 may be made of the ferromagnetic material, and the second positioning portion 122 may be made of the magnetic material. The aforementioned effect of increasing the coupling and positioning of the first positioning portion 112 and the second positioning portion 122 would be achieved as well.

Please continue to refer to FIG. 2. In the embodiment that the cavity 1121 is provided by the first positioning portion 112 that faces the second positioning portion 122 mentioned above, the first positioning portion 112 may further comprise a positioning ball 1122 and a first sleeve 1124, and the first sleeve 1124 may be provided in the cavity 1121. In this embodiment, the positioning ball 1122 may be provided in the first sleeve 1124, and more than one half of the volume of the positioning ball 1122 may be located in the first sleeve 1124. In this embodiment, the second positioning portion 122 may be a positioning hole, the second positioning portion 122 may further comprise a second sleeve 1221, the second sleeve 1221 may be provided in the positioning hole, and the positioning ball 1122 and the second sleeve 1221 may be coupled to each other separably.

Preferably, the embodiment that the first positioning portion 112 further comprises the first sleeve 1124 could combine with the embodiment that the first positioning portion 112 further comprises the spring 1123 mentioned above. In this preferable embodiment, the spring 1123 may be provided in the first sleeve 1124, and the spring 1123 may be further provided between the positioning ball 1122 and a bottom portion of the cavity 1121 such that the positioning ball 1122 is limitedly movable determined by an elastic force of the spring 1123 in the first sleeve 1124. As mentioned above, in this embodiment, the positioning ball 1122 may be made of a magnetic material, and the second sleeve 1221 may be made of a ferromagnetic material. In another embodiment, the positioning ball 1122 may be made of a ferromagnetic material, and the second sleeve 1221 may be made of a magnetic material. The aforementioned effect of increasing the coupling and positioning of the first positioning portion 112 and the second positioning portion 122 would be achieved.

Please refer to FIG. 2. In an embodiment of the present invention, the first part 11 may further have a socket 113, and the second part 12 may further have a through hole 123. In addition, the mutual engagement structure for a pet leash according to the present invention may further comprise a rope 2, wherein the rope 2 has two opposite ends defined respectively as a first end 21 and a second end 22. The first end 21 of the rope 2 may be fixedly provided in the socket 113 by glue, adhering agent, etc., and the second end 22 of the rope 2 may pass through and protrude from the through hole 123, wherein a portion of the rope 2 may be also fixedly provided in the through hole 123 by glue, adhering agent, etc.

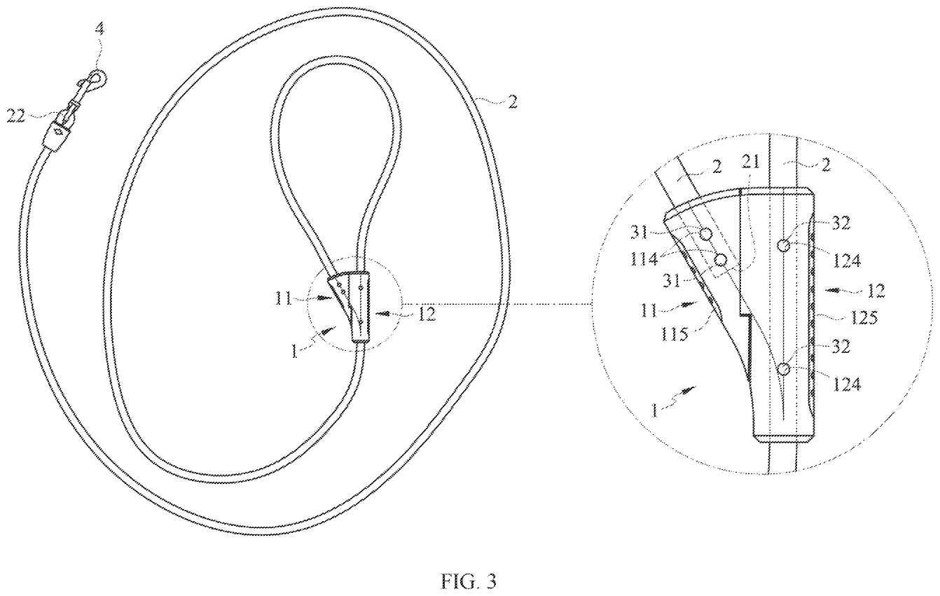

Please further refer to FIG. 3 together. In another embodiment of the present invention, the rope 2 has two opposite ends defined respectively as a first end 21 and a second end 22. In this embodiment, the first end 21 of the rope 2 may be provided in the socket 113, and the second end 22 of the rope 2 may pass through and protrude from the through hole 123, wherein a portion of the rope 2 may be provided in the through hole 123. Preferably, in this embodiment, the mutual engagement structure for a pet leash according to the present invention may further comprise a first fixing element 31 and a second fixing element 32, wherein the first part 11 may further comprise a first through bore 114, and the first through bore 114 extends through the socket 113 and penetrates the first part 11. The second part 12 may further comprise a second through bore 124, and the second through bore 124 extends through the through hole 123 and penetrates the second part 12. The first fixing element 31 may pass through the first through bore 114 and penetrate the rope 2 in the socket 113, and the second fixing element 32 may pass through the second through bore 124 and penetrate the rope 2 in the through hole 123. In this embodiment, the first fixing element 31 and the second fixing element 32 may be, for example, nails, pins or rods made of a metal material. In other embodiments, the number of the first through bore 114 or the second through bore 124 may be single or plural. Relatively, the number of the first fixing element 31 and the second fixing element 32 corresponds to the number of the first through bore 114 and the second through bore 124, wherein the first fixing element 31 passes through the first through bore 114 and penetrates the rope 2 in the socket 113, and the second fixing element 32 passes through the second through bore 124 and penetrates the rope 2 in the through hole 123.

Please refer to FIG. 3. The mutual engagement structure for a pet leash according to the present invention may comprise a fastening element 4, wherein the fastening element 4 is coupled to the second end 22 of the rope 2 detachably. The fastening element 4 may be, for example, a hook buckle with a spring latch.

Please refer to FIG. 3. In another embodiment of the present invention, the first part 11 may be provided with a first anti-slip portion 115, and the first anti-slip portion 115 and the first coupling portion 111 may be provided on two opposite sides of the first part 11 respectively. The second part 12 may also be provided with a second anti-slip portion 125, and the second anti-slip portion 125 and the second coupling portion 121 may be provided on two opposite sides of the second part 12 respectively. In this embodiment, the first anti-slip portion 115 or the second anti-slip portion 125 may be a structure composed of a plurality of concave portions and convex portions interlaced to each other. In other embodiments, the first anti-slip portion 115 or the second anti-slip portion 125 may be made of an anti-slip material such as rubber, silica gel, etc.

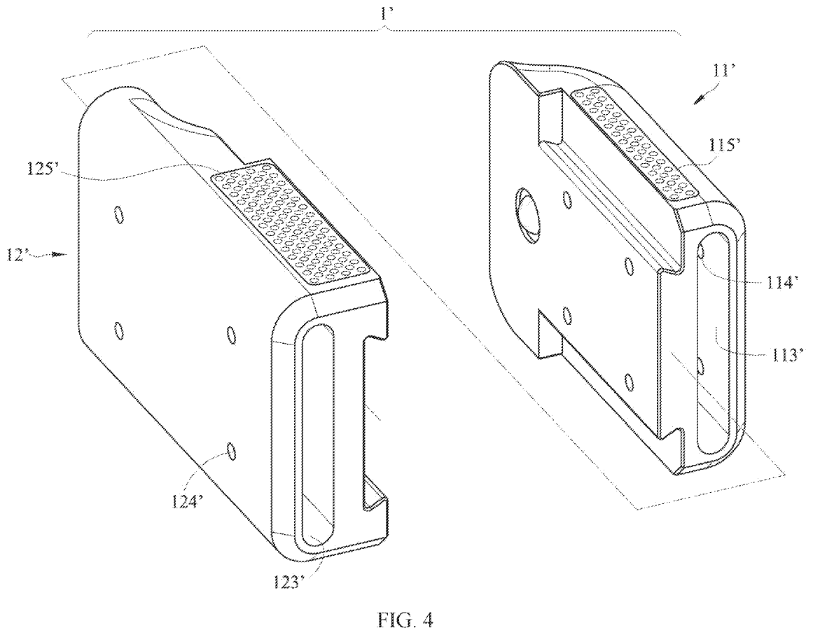

Please continue to refer to FIG. 4. In another embodiment of the present invention, the main body 1′ of the mutual engagement structure for a pet leash according to the present invention also comprises a first part 11′ and a second part 12′. Compared to the aforementioned embodiments shown in FIG. 1 to FIG. 3, the main difference is that the shape of the first part 11′ and the second part 12′ is flatter than that of the structures shown in FIG. 1 to FIG. 3. The shape of first part 11 and the second part 12 shown in FIG. 1 to FIG. 3 is much thicker and higher. Similarly, in the embodiment of FIG. 4, the shape of a socket 113′ provided in the first part 11′ and a through hole 123′ provided in the second part 12′ is also flatter than that of the socket 113 provided in the first part 11 and the through hole 123 provided in the second part 12. The first part 11′ further comprises a first through bore 114′ and the second part 12′ further comprises a second through bore 124′. Compared to the first through bore 114 penetrating two opposite sides of the first part 11 where the side of the first part 11 facing the second part 12 is between the two opposite sides and the second through bore 124 penetrating two opposite sides where the side of the second part 12 facing the s first part 11 is between the two opposite sides, the first through bore 114′ could penetrate the first part 11′ from the side facing the second part 12′ to the opposite side and the second through bore 124′ could penetrate the second part 12′ from the side facing the first part 11′ to the opposite side according to the changes on the shape of the first part 11′ and the second part 12′ in the embodiment shown in FIG. 4. Corresponding to the positions of the first through bore 114′ and the second through bore 124′, the first anti-slip portion 115′ included in the first part 11′ is provided on two opposite sides of the first part 11′ where the side of the first part 11′ facing the second part 12′ is between the two opposite sides, and the second anti-slip portion 125′ included in the second part 12′ is provided on two opposite sides of the second part 12′ where the side of the second part 12′ facing the first part 11′ is between the two opposite sides. The cylindrical rope is suitable for the embodiments shown in FIG.1 to FIG. 3, and the flat rope made by weaving is suitable for the embodiment shown in FIG. 4. The other components or structures shown in FIG. 4 are substantially the same as those shown in FIG.1 to FIG. 3, so accordingly it is not explained in any more detail here.

In summary, the mutual engagement structure for a pet leash of the present invention utilizes the structures comprising the first part and the second part coupled to each other separably, together with the first coupling portion and the first positioning portion provided on the first part, and the second coupling portion and the second positioning portion provided on the second part so that the users could easily open or close the loop when the rope is fixedly provided on the first part and the second part. It can be easily and accurately operated by one-hand for the users. Besides, the first coupling portion and the second coupling portion have respectively corresponding protruding structures and groove structures, which can enhance the stability of the closed loop. Furthermore, when the first positioning portion and the second positioning portion are respectively corresponding hemispherical protuberance and hemispherical recess, the positioning effect of the combination of the first part and the second part may be improved. In particular, when the first positioning portion and the second positioning portion are respectively made of magnetic material and ferromagnetic material, the positioning and coupling effects of the first part and the second part can be further improved. Therefore, the mutual engagement structure for a pet leash of the present invention can be effectively solved the deficiencies of the prior art.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A mutual engagement structure for a pet leash, comprising:
a main body comprising a first part and a second part, wherein the first part and the second part are coupled to each other separably so as to form the main body;
a first coupling portion provided on a side of the first part that faces the second part;
a second coupling portion provided on a side of the second part that faces the first part, wherein the second coupling portion and the first coupling portion are coupled to each other separably enabling the first part and the second part to form the main body;
a first positioning portion provided on the side of the first part that faces the second part; and
a second positioning portion provided on the side of the second part that faces the first part, wherein the second positioning portion and the first positioning portion are coupled to each other separably.

2. The mutual engagement structure for a pet leash as claimed in claim 1, wherein the first coupling portion has groove structures formed respectively in two opposite edges of the side of the first part that faces the second part, and the second coupling portion has protruding structures formed respectively on two opposite edges of the side of the second part that faces the first part.

3. The mutual engagement structure for a pet leash as claimed in claim 1, wherein the first coupling portion has protruding structures formed respectively on two opposite edges of the side of the first part that faces the second part, and the second coupling portion has groove structures formed respectively in two opposite edges of the side of the second part that faces the first part.

4. The mutual engagement structure for a pet leash as claimed in claim 1, wherein the first positioning portion is a generally hemispherical protuberance, and the second positioning portion is a generally hemispherical recess corresponding to the generally hemispherical protuberance.

5. The mutual engagement structure for a pet leash as claimed in claim 1, wherein the side of the second part that faces the first part further comprises a guide groove, and the guide groove is substantially parallel to the second coupling portion and is connected to the second positioning portion.

6. The mutual engagement structure for a pet leash as claimed in claim 1, wherein the first positioning portion is made of a magnetic material, and the second positioning portion is made of a ferromagnetic material; or the first positioning portion is made of the ferromagnetic material, and the second positioning portion is made of the magnetic material.

7. The mutual engagement structure for a pet leash as claimed in claim 1, wherein the first positioning portion is formed with a cavity with its opening facing the second positioning portion, and the first positioning portion further comprises a positioning ball with more than one half of its volume located in the cavity; and wherein the second positioning portion is a positioning hole, and the positioning ball and the positioning hole are coupled to each other separably.

8. The mutual engagement structure for a pet leash as claimed in claim 7, wherein the first positioning portion further comprises a spring provided between the positioning ball and a bottom portion of the cavity such that the positioning ball is limitedly movable determined by an elastic force of the spring.

9. The mutual engagement structure for a pet leash as claimed in claim 7, wherein the positioning ball is made of a magnetic material, and the second positioning portion is made of a ferromagnetic material; or the positioning ball is made of the ferromagnetic material, and the second positioning portion is made of the magnetic material.

10. The mutual engagement structure for a pet leash as claimed in claim 1, wherein the first positioning portion is formed with a cavity with its opening facing the second positioning portion, and the first positioning portion further comprises a positioning ball and a first sleeve, wherein the first sleeve is provided in the cavity, and the positioning ball is provided in the first sleeve with more than one half of its volume located in the first sleeve; and wherein the second positioning portion is a positioning hole, and the second positioning portion further comprises a second sleeve provided in the positioning hole, and wherein the positioning ball and the second sleeve are coupled to each other separably.

11. The mutual engagement structure for a pet leash as claimed in claim 10, wherein the first positioning portion further comprises a spring provided in the first sleeve, and the spring is provided between the positioning ball and a bottom portion of the cavity such that the positioning ball is limitedly movable determined by an elastic force of the spring.

12. The mutual engagement structure for a pet leash as claimed in claim 10, wherein the positioning ball is made of a magnetic material, and the second sleeve is made of a ferromagnetic material; or the positioning ball is made of the ferromagnetic material, and the second sleeve is made of the magnetic material.

13. The mutual engagement structure for a pet leash as claimed in claim 1, wherein the first part has a socket, and the second part has a through hole.

14. The mutual engagement structure for a pet leash as claimed in claim 13, further comprising a rope, wherein the rope has a first end and a second end opposite to the first end, and the first end of the rope is fixedly provided in the socket, and the second end of the rope passes through and protrudes from the through hole, and a portion of the rope is fixedly provided in the through hole.

15. The mutual engagement structure for a pet leash as claimed in claim 13, further comprising a rope, wherein the rope has a first end and a second end opposite to the first end, and the first end of the rope is provided in the socket, and the second end of the rope passes through and protrudes from the through hole, and a portion of the rope is provided in the through hole.

16. The mutual engagement structure for a pet leash as claimed in claim 15, further comprising a first fixing element and a second fixing element, wherein the first part comprises a first through bore, and the first through bore extends through the socket and penetrates the first part; wherein the second part comprises a second through bore, and the second through bore extends through the through hole and penetrates the second part;
and wherein the first fixing element passes through the first through bore and penetrates the rope in the socket, and the second fixing element passes through the second through bore and penetrates the rope in the through hole.

17. The mutual engagement structure for a pet leash as claimed in claim 15, further comprising a fastening element, wherein the fastening element is coupled to the second end of the rope detachably.

18. The mutual engagement structure for a pet leash as claimed in claim 13, wherein the first part is provided with a first anti-slip portion, and the first anti-slip portion and the first coupling portion are provided on two opposite sides of the first part respectively; or the second part is provided with a second anti-slip portion, and the second anti-slip portion and the second coupling portion are provided on two opposite sides of the second part respectively.
